(19) United States
(12) Patent Application Publication
(10) Pub. No.: US 2014/0251229 A1
(43) Pub. Date: Sep. 11, 2014

(54) Swinging Perch and Method

(71) Applicant: Jennifer Connell, Columbia, MO (US)

(72) Inventor: Jennifer Connell, Columbia, MO (US)

(21) Appl. No.: 14/194,697

(22) Filed: Mar. 1, 2014

Related U.S. Application Data
(60) Provisional application No. 61/773,073, filed on Mar. 5, 2013.

(51) Int. Cl. A01K 31/12

(52) U.S. Cl. CPC A01K 31/12
USPC 119/531; 119/702

(57) ABSTRACT

A bird swing includes a substantially horizontal perch for a bird, at least two substantially rigid and substantially vertical perch stabilizer bars connected to the perch, at least two substantially rigid and substantially vertical stabilizing bars movably connected to the at least two perch stabilizer bars, at least two flexible cords connecting upper portions of the at least two stabilizing bars to a support, and at least one substantially horizontal cross member connected to the at least two flexible cords and configured to maintain the at least two flexible cords an approximately constant distance apart.

### REFERENCE TO RELATED APPLICATION

The present application claims the benefit of U.S. Provisional Application No. 61/773,073, filed Mar. 5, 2013, entitled “Swinging Perch and Method,” the contents of which are herein incorporated by reference.

### BACKGROUND OF THE INVENTION

The present invention relates to a swinging perch used primarily for chickens. Chickens are generally kept in coops or enclosed areas. Without activity, they can become bored. This can cause stress and thus lower production of eggs and meat. Chicken owners are looking for options to relieve stress in their flocks. Increasingly, people are keeping chickens as pets. However, they want to see their chicken do something interesting besides sitting in a coop eating. Stationary perches do not have flexible parts that will allow for movement, while there are swings made for caged birds. The current swing designs are not intended or suited for chickens.

Current chicken perches are stationary. Prior art fails to accommodate chickens in size, by being too small or too big, or not having a perch that the chicken can grasp. There is an overall lack to consider application of use by a chicken. It is not widely known that chickens can and will use a swing. There is a need for solutions to these and other problems.

### SUMMARY OF THE INVENTION

According to one embodiment of the present invention, a bird swing comprises: a substantially horizontal perch for a bird; at least two substantially vertical stabilizing bars movably connected to the perch; and at least two flexible cords connecting upper portions of the at least two stabilizing bars to a support.

In one aspect, the at least two stabilizing bars are substantially rigid. In one aspect, the bird swing further comprises at least two perch stabilizer bars connected to the perch, wherein the at least two stabilizing bars are movably connected to the at least two perch stabilizer bars. In one aspect, the at least two perch stabilizer bars are substantially vertical and have lengths between approximately three and six inches.

In one aspect, the bird swing further comprises at least one substantially horizontal cross member connected to the at least two flexible cords and configured to maintain the at least two flexible cords an approximately constant distance apart. In one aspect, the at least one substantially horizontal cross member comprises a hole at each end and rests on knots in the at least two flexible cords. In one aspect, the at least one substantially horizontal cross member is located between approximately one and three feet above the perch.

In one aspect, the bird swing further comprises at least two rope buckles configured to allow a height of the perch to be adjusted relative to the support, each rope buckle comprising at least two holes through which one of the at least two flexible cords passes.

In one aspect, the perch comprises perch grips configured to improve a gripping of feet of the bird to the perch. In one aspect, the perch grips comprise a high-friction material. In one aspect, the perch grips comprise a ridged shape. In one aspect, the perch has a cross section having a substantially rounded upper portion and a substantially rectangular lower portion.

According to one embodiment of the present invention, a method of entertaining a chicken comprises: providing the bird swing as described; and providing a chicken.

According to one embodiment of the present invention, a bird swing comprises: a substantially horizontal perch for a bird; at least two flexible cords connecting the perch to a support; and at least one substantially horizontal cross member connected to the at least two flexible cords and configured to maintain the at least two flexible cords an approximately constant distance apart.

According to one embodiment of the present invention, a bird swing comprises: a substantially horizontal perch for a bird; at least two substantially rigid and substantially vertical perch stabilizer bars connected to the perch; at least two substantially rigid and substantially vertical stabilizing bars movably connected to the at least two perch stabilizer bars; at least two flexible cords connecting upper portions of the at least two stabilizing bars to a support; and at least one substantially horizontal cross member connected to the at least two flexible cords and configured to maintain the at least two flexible cords an approximately constant distance apart.

In one aspect, the bird swing further comprises at least two rope buckles configured to allow a height of the perch to be adjusted relative to the support, each rope buckle comprising at least two holes through which one of the at least two flexible cords passes. In one aspect, the perch comprises perch grips configured to improve a gripping of feet of the bird to the perch.

### BRIEF DESCRIPTION OF THE DRAWINGS

FIG. 1 shows a perspective view of one embodiment of the present invention shown in use.

FIG. 2 shows an exploded view of one embodiment of the present invention.

FIG. 3 shows a side view of one embodiment of the present invention.

FIG. 4 shows a perspective view of another embodiment of the present invention.

FIG. 5 shows a cross sectional view of one embodiment of the present invention taken about line 5-5 in FIG. 4.

FIG. 6 shows a perspective view of another embodiment of the present invention.

FIG. 7 shows a perspective view of another embodiment of the present invention shown in use and attached to an overhead support 28.

FIG. 8 shows perspective views of rope buckles 36.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Referring now to the drawings, the following reference numbers may refer to elements of the invention:

12: is the perch.

14: are the connectors (also known as S-hooks).

16: are the stabilizing bars (also known as side ties).

18: are the cords, which may comprise rope or cable.

20: is the bird or chicken.

22: is the cross member (also known as cross bar).

24: are the perch stabilizer bars (also known as tongues).

26: are the knots.

28: is the overhead support.

30: are the perch grips.

32: is the substantially rounded upper portion of the cross section of the perch 12.

34: is the substantially rectangular lower portion of the cross section of the perch 12.

36: are the cord buckles.

38: are the holes in the cord buckles 36.

Referring now to the drawings, a bird swing comprises a perch 12, connected to an overhead support 28, on which a bird, such as a chicken, may swing. The perch 12 comprises any solid material, such as but not limited to plastic, metal, rubber, wood, and so forth. Referring to FIG. 3, the perch 12 may have a cross section having a substantially rounded upper portion 32 and a substantially rectangular lower portion 34, which may be identified by a traditional “mailbox” shape or cross section. The substantially rounded upper portion 32 allows the feet of a bird to comfortably and securely grip and/or hold the perch 12, while the substantially rectangular lower portion 34 allows distal ends of the feet (e.g., claws) to press against the perch 12 to torque/turn it, allowing the bird to turn the perch 12 and “pump” the swing. Alternatively or in addition, the perch 12 comprises perch grips 30 configured to improve a gripping of feet of the bird to the perch 12. The perch grips 30 may include physically protruding, extruded, raised, ridged, or bumpy regions to provide additional gripping contact and/or friction with the bird's feet, and/or may comprise a high-friction material, such as rubber or a high-friction polymer coating, to increase friction between the perch 12 and the bird's feet.

The perch 12 may be directly connected to the overhead support 28 via cords 18, which may comprise rope or cable of any known material (such as twine or fiber, composite materials, metal, plastic, and so forth), or via one or more additional structures, such as but not limited to the following: connectors 14, stabilizing bars 16, and perch stabilizer bars 24. Connectors 14 may allow the perch 12 to swivel, move, and/or rotate relative to the cords 18 or other structures, and may comprise, for example, S-hooks or any other connector that allows rotatable connection.

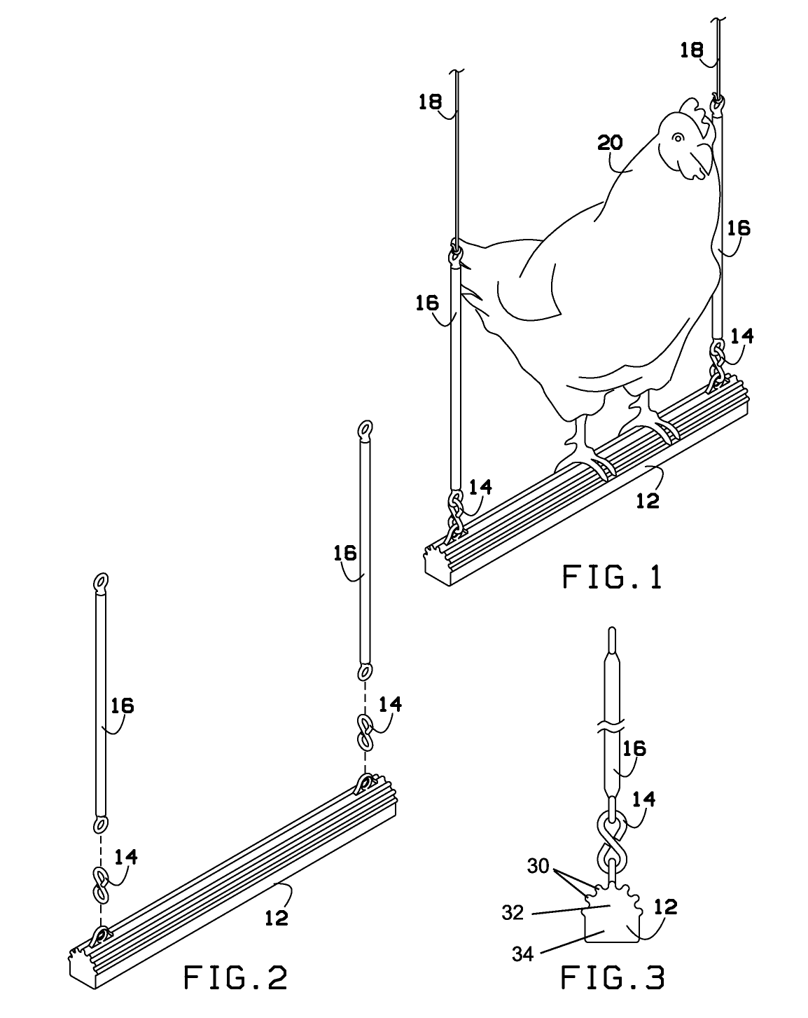

Referring now to FIGS. 1-3, stabilizing bars 16 may comprise any solid and rigid or semi-rigid material, such as but not limited to plastic, metal, rubber, wood, and so forth. These stabilizing bars 16 help to maintain a straightness of the swing where the bird or chicken 20 is located, unlike the cords 18 which may readily bend. These stabilizing bars 16 may have a length comparable to a height of the bird or chicken 20 using the swing, such as approximately 10 to 20 inches in length, and may have loops, holes, and/or other attachment points on ends, allowing the stabilizing bars 16 to be attached between the perch 12 and the cords 18 such as via knots 26 or any other known means of connection. These stabilizing bars 16 may be attached directly to the perch 12 or via connectors 14 and/or perch stabilizing bars 24.

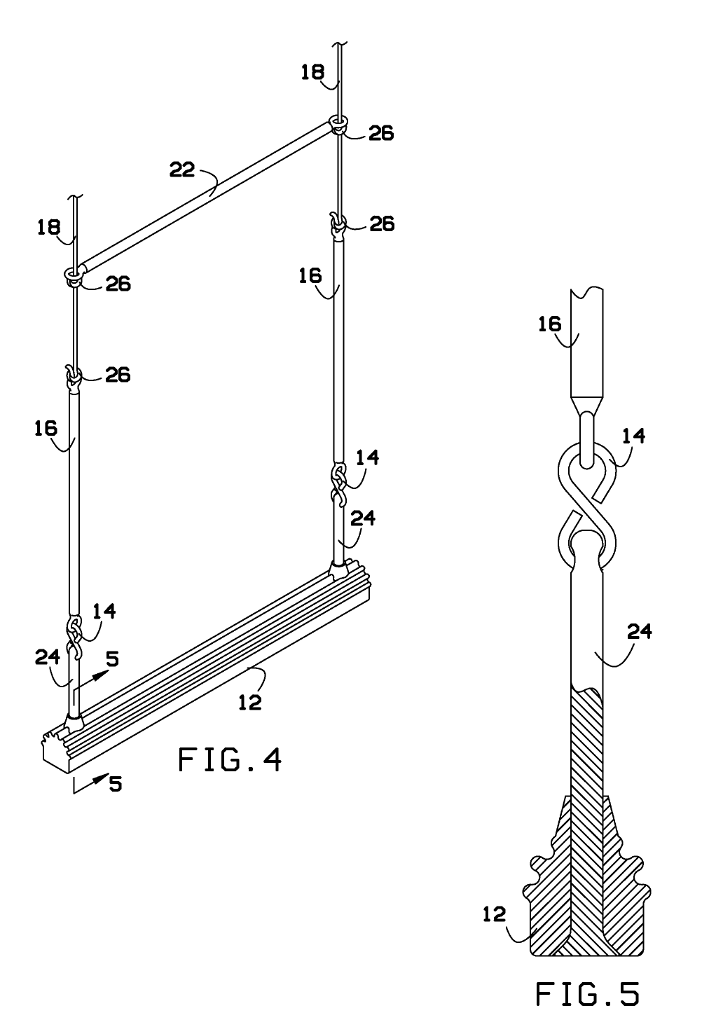

Referring now to FIGS. 4-6, perch stabilizing bars 24 may comprise extensions or tongues that are connected to or integrally formed with the perch 12. They may be connected by any means known; in FIG. 5, a perch stabilizing bar 24 is shown with a flared bottom mating into a correspondingly shaped hole and region of the perch 12, allowing the perch 12 to rest on the flared bottom of the perch stabilizing bar 24. The height of the perch 12 relative to the perch stabilizing bar 24 may be adjustable by any means known. Each perch stabilizing bar 24 may have a length approximately corresponding to a length of the legs of the bird or chicken 20, such as between approximately 2 and 8 inches, or between approximately 4 and 6 inches, allowing the bird or chicken 20 to “pump” the swing and allow the perch 12 to comfortably rotate about the connectors 14. The perch stabilizing bars 24 may form an approximately right angle relative to the perch 12 and may be located at or near ends of the perch 12, allowing the perch 12 to be connected to and/or hung from the cords 18 and/or stabilizing bars 16 via the perch stabilizing bars 24.

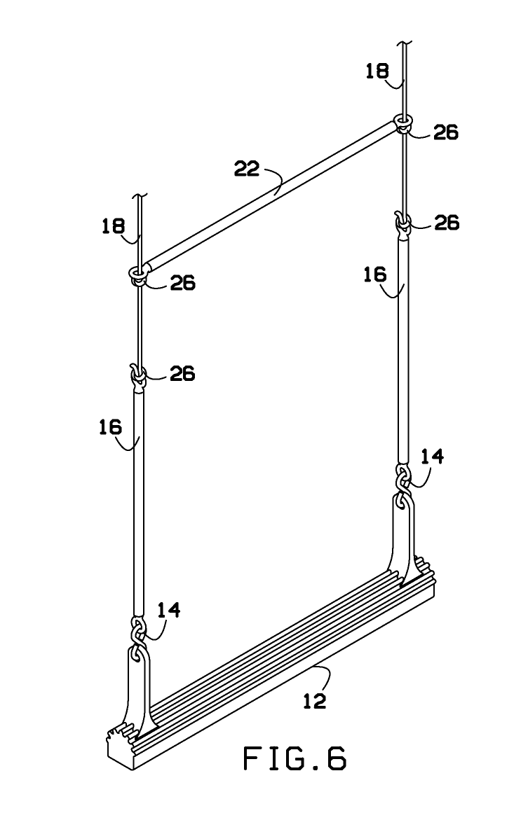

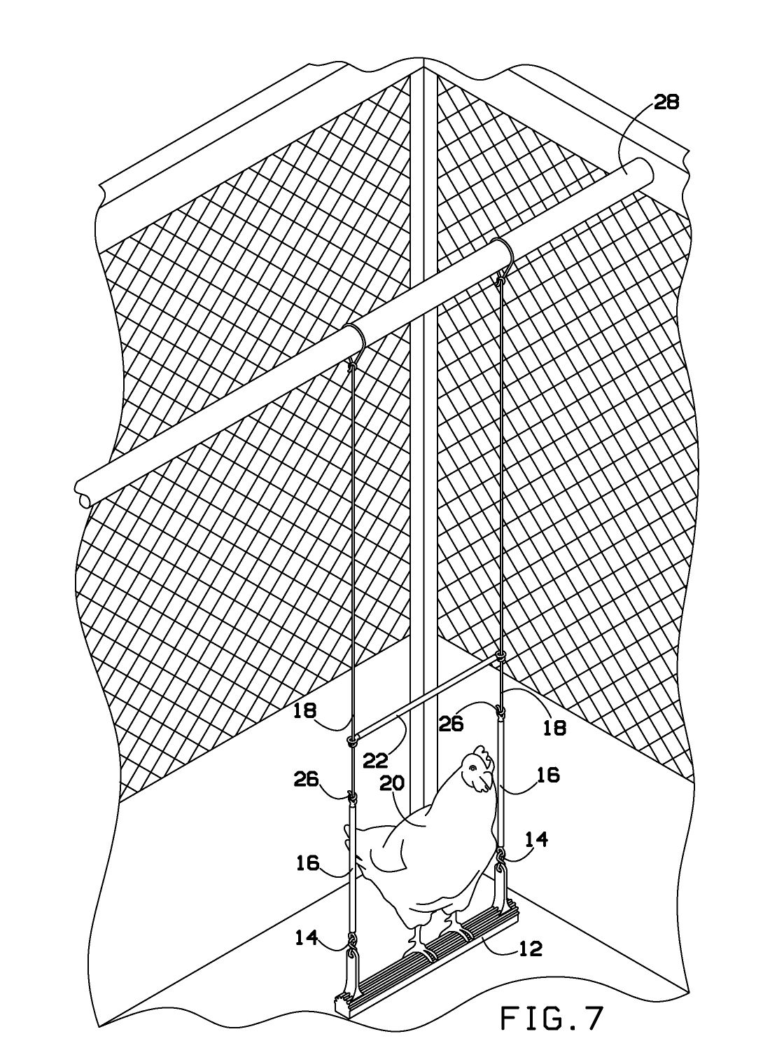

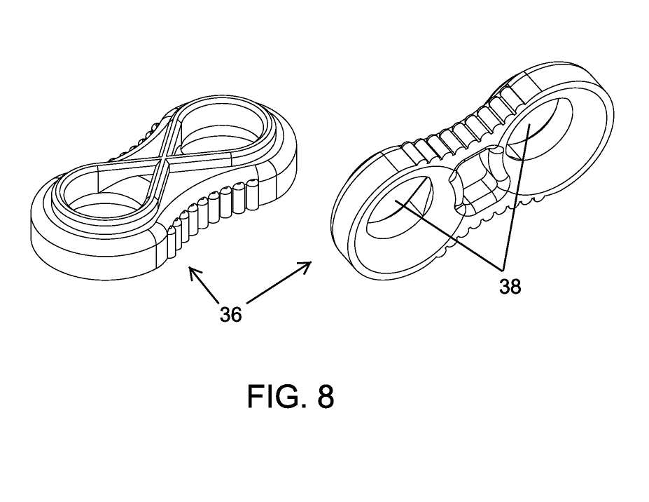

Cross member or bar 22 may span a horizontal distance between the cords 18 and may connect them and/or keep them at an approximately fixed distance relative to each other. An advantage to this cross member 22 is that when a bird or chicken 20 jumps on or off the swing, the cross member 22 helps to prevent tangling or contact between the two cords 18. The cross member 22 may comprise any solid and rigid or semi-rigid material, such as but not limited to plastic, metal, rubber, wood, and so forth, and may include holes, loops, etc., at opposite ends through which cords 18 may pass, or may simply be attached to cords 18 through any means known. If the cross member 22 includes holes through which cords 18 pass, cords 18 may include knots 26 onto which the cross member 22 rests, as shown in FIG. 6.

Referring now to FIG. 8, cord buckles 36 may be used to adjustably connect two regions of a cord 18 to itself. Each cord buckle 36 comprises at least two holes 38, as shown, and a cord 18 may be passed through both holes 38, creating a loop in the cord 18, and another region of the cord 18 may be passed through the loop that was created by passing the cord 18 through the two holes. When the cord 18 is then pulled or tightened, the loop clamps down on the another region of the cord 18, causing it to be secured. The loop may be loosened to allow the cord 18 to be adjusted as desired.

The present invention also includes use of the swing, such as entertaining a bird or chicken 20 by providing the swing in a chicken coop or other location of chicken 20, allowing the chicken 20 to jump on and swing on the swing. The present invention also includes adjusting the swing, such as by adjusting locations of knots 26, cord buckles 36, a length of the stabilizing bars 16, a length of the cords 18, etc.

Other embodiments of the present invention are described below.

One aspect of the present invention provides large domesticated fowl the specific design that they need to enjoy a perch that moves back and forth in reaction to the force that the fowl sitting on the perch produces. One aspect of the present invention is designed to accommodate the size of the chicken. The non-flexible perch 12 may be set between the flexible pieces to allow the perch 12 to move back and forth in reaction to the force the chicken 20 produces while sitting on the perch 12.

Referring now to the drawings, the perch 12 is attached to first ends of two stabilizing bars 16 with two connectors 14 connecting the perch 12 to the stabilizing bars 16. The second end of the two stabilizing bars 16 may include attachment means to connect cords, ropes, or chains, the other ends of which attach to an overhead ceiling or support 28.

The perch 12 may be made of a solid, rigid, and/or non-flexing material of a cylindrical or partially cylindrical shape and may have a textured surface. It may be of a size and length to accommodate a chicken, allowing the bird to grip and thus stand on the perch 12. The perch 12 may be made with two raised loops or eyelets, such as connectors or S-hooks 14, that provide a hole for attaching the perch 12 to the two stabilizing bars 16.

The two stabilizing bars 16 may be made of any rigid material, such as molded plastic, and have holes on either ends for connection. The stabilizing bars 16 may provide safety for the fowl and stabilization for the swing when the bird gets on and off. The two connectors 14 may allow for attachment and flexibility. They may be used to attach the stabilizing bars 16 to the perch 12 using the eyelets on each end of the perch 12 and the holes in the first ends of the stabilizing bars 16. The connectors 14 may be made from pre-manufactured hooks and may be sized relative to the perch 12 and the stabilizing bars 16.

The two pieces of cord, rope or chain 18 give length, flexibility, and means of attachment. The first ends may be attached through the second end of the stabilizing bars 16 by tying or connecting. The second ends may then be attached to a stationary structure above the perch 12 in a manner allowing the perch to hang approximately horizontal to the ground, and at an appropriate height from the ground as to allow the chicken to jump up on the perch and swing in a back and forth motion. The swing moves in a back and forth motion in reaction to the force created by the chicken or other similar large domesticated fowl.

The perch 12 may be manufactured from a mold process using a plastic or a blend of plastics formed in the mold. One could carve the shape out of a suitable material by hand. The two connectors 14 allowing for attachment could be made out of stiff wire or another component could be used. The two stabilizing bars 16 may be manufactured from a mold using a plastic or a blend of plastics formed in the mold. One could make them from carving or shaping the piece out of suitable material. One could also form a similar shape out of a pliable metal and get a usable part. The two pieces of cord 18 may be cut from a bulk supply of pre-manufactured cord. One could make the cord out of fibers with the right tools to bind the fibers into rope or cord.

The pieces may be assembled by hand. This can be done by connecting one of the two stabilizing bars 16 using one of the connectors 14 to one of the eyelets of the perch 12. Pliers, or a press, may then be used to close ends of the connector 14 for a secure attachment. One piece of the cord may then be threaded through the second end of the hole and knotted on the end of the stabilizing bar 16 that is now connected to the perch 12 close to the hole in the stabilizing bar 16, for a secure attachment. These steps may be repeated on the other side of the perch 12 with the remaining duplicate components. The assembled swing may then be attached to a stationary object by tying the remaining end of each piece of cord 18 to a stationary object(s). While there is some flexibility in the distance between the two points of attachment to the stationary object, it may be approximately equal to the length of the perch 12. The installation or attachment of the assembled swing may be done so that the perch 12 is approximately horizontal to the ground. The chicken swing also may be placed at a height from the ground that can be accessed by the chickens it is intended for.

The stabilizing bars 16 could also be reconfigured so as to attach in a different manner to the perch 12 and/or the stationary object that supports the swing. Elements could be added in the way of including mounts both freestanding and standing and ones that could be attached to the wall or ceiling. One could also design a mechanism that would cause the perch to stop or slow the motion when the bird jumped off.

Art could be added to change the look of the chicken swing while still maintaining its use of providing a perch that moved back and forth in reaction to the force that the fowl sitting on the perch produces. The designs could include any number of ideas including color, shape and materials that mimicked or suggested a landscape, character (real or fictional), hobby, tool, holiday, culture, auto, animal, or situation. Another improvement could include multiple chicken use. A mount could be designed to accommodate several swings or room for multiple chickens to use at the same time, or a perch 12 having an appropriate length for one or multiple chickens. There could also be a mechanism added to adjust for height changes needed as the chickens grow. One could add design and or mechanisms that would keep the swing from twisting or moving in a manner other than back and forth.

The components or elements of this design could be shuffled or interchanged by moving the attachment to a different location on the perch 12. The stabilizing bars 16 could be combined or become one piece of the perch and then use attachments to connect to pieces of cord 18. Alternatively, the design could be reconfigured in the manner of connection of two pieces of cord (or chain, strap, cable, rod, or rope, etc.) that are run through a hole under or through the perch 12 as one piece with two ends. The perch could be reconfigured as long as it is able to be of a size and shape that allows the chicken to grasp or perch on it.

One aspect of a swinging perch or a chicken swing could be installed in a coop or area where chickens are kept that would allow chickens to access the perch. The swing gives the large fowl an activity that reduces boredom. Watching the chickens swinging is also enjoyable for people.

It should be understood, of course, that the foregoing relates to exemplary embodiments of the invention and that modifications may be made without departing from the spirit and scope of the invention.

What is claimed is:

1. A bird swing, comprising:
a substantially horizontal perch for a bird;
at least two substantially vertical stabilizing bars movably connected to the perch; and
at least two flexible cords connecting upper portions of the at least two stabilizing bars to a support.

2. The bird swing as claimed in claim 1, wherein the at least two stabilizing bars are substantially rigid.

3. The bird swing as claimed in claim 1, further comprising at least two perch stabilizer bars connected to the perch, wherein the at least two stabilizing bars are movably connected to the at least two perch stabilizer bars.

4. The bird swing as claimed in claim 3, wherein the at least two perch stabilizer bars are substantially vertical and have lengths between approximately three and six inches.

5. The bird swing as claimed in claim 1, further comprising at least one substantially horizontal cross member connected to the at least two flexible cords and configured to maintain the at least two flexible cords an approximately constant distance apart.

6. The bird swing as claimed in claim 5, wherein the at least one substantially horizontal cross member comprises a hole at each end and rests on knots in the at least two flexible cords.

7. The bird swing as claimed in claim 5, wherein the at least one substantially horizontal cross member is located between approximately one and three feet above the perch.

8. The bird swing as claimed in claim 1, further comprising at least two rope buckles configured to allow a height of the perch to be adjusted relative to the support, each rope buckle comprising at least two holes through which one of the at least two flexible cords passes.

9. The bird swing as claimed in claim 1, wherein the perch comprises perch grips configured to improve a gripping of feet of the bird to the perch.

10. The bird swing as claimed in claim 9, wherein the perch grips comprise a high-friction material.

11. The bird swing as claimed in claim 9, wherein the perch grips comprise a ridged shape.

12. The bird swing as claimed in claim 1, wherein the perch has a cross section having a substantially rounded upper portion and a substantially rectangular lower portion.

13. A method of entertaining a chicken, comprising:
providing the bird swing as claimed in claim 1; and
providing a chicken.

14. A bird swing, comprising:
a substantially horizontal perch for a bird;
at least two flexible cords connecting the perch to a support; and
at least one substantially horizontal cross member connected to the at least two flexible cords and configured to maintain the at least two flexible cords an approximately constant distance apart.

15. A bird swing, comprising:
a substantially horizontal perch for a bird;
at least two substantially rigid and substantially vertical perch stabilizer bars connected to the perch;
at least two substantially rigid and substantially vertical stabilizing bars movably connected to the at least two perch stabilizer bars;
at least two flexible cords connecting upper portions of the at least two stabilizing bars to a support; and
at least one substantially horizontal cross member connected to the at least two flexible cords and configured to maintain the at least two flexible cords an approximately constant distance apart.

16. The bird swing as claimed in claim 15, further comprising at least two rope buckles configured to allow a height of the perch to be adjusted relative to the support, each rope buckle comprising at least two holes through which one of the at least two flexible cords passes.

17. The bird swing as claimed in claim 15, wherein the perch comprises perch grips configured to improve a gripping of feet of the bird to the perch.
